(19) United States
(12) Patent Application Publication
(10) Pub. No.: US 2006/0265374 A1
(43) Pub. Date: Nov. 23, 2006

(54) Multipurpose database

(76) Inventor: Thomas W. Smith, Fredericksburg, VA (US)

Correspondence Address: NAVAL SURFACE WARFARE CENTER, DAHLGREN DIVISION;OFFICE OF COUNSEL, CODE XDC1, 17320 DAHLGREN ROAD, DAHLGREN, VA, 22448-5110, US

(21) Appl. No.: 11/134,607

(22) Filed: May 19, 2005

(51) Int. Cl. G06F 17/30

(52) U.S. Cl. 707/9

(57) ABSTRACT

A multipurpose database for the creation, storage and evaluation of multimedia proposal files. The database provides a common interface for the submission of all proposals to large organizations that have a wide variety of proposals submitted to the organization for consideration. The database assists in the evaluation process by automating sub-processes, such as classification and weighted scoring, of completed submissions. Other evaluation processes are completed be evaluators that receive notification from the database whenever they are needed in the evaluation process. The database is preferably accessed via the Internet and web browser interface is used to guide proposal submitters through the submission process. Submitters are allowed to upload existing files into the database during the submission process. When a proposal file is ready for evaluation the submitter sets a flag that triggers the automated evaluation process.

### STATEMENT OF GOVERNMENT INTEREST

The invention described herein was made in the performance of official duties by employees of the Department of the Navy and may be manufactured, used, licensed by or for the Government for any governmental purpose without the payment of any royalty thereon.

### FIELD OF THE INVENTION

The present invention relates generally to a database that assists in evaluating submitted proposals, and more specifically to a database that provides uniform interfaces for the submitters of proposals and for the reviewers of the proposals, wherein multimedia information can be input as proposal information.

### BACKGROUND

Multimedia is the presentation of information using the combination of text, sound, pictures, animation, and video. Common multimedia computer applications include games, learning software, and reference materials. Multimedia applications can include predefined associations, known as hyperlinks that enable users to switch between media elements and topics. Thoughtfully presented multimedia can enhance the learning experience for the end user and make the completion of required tasks much simpler. Multimedia applications are computer programs that may be stored on a memory device such as a compact disc. They may also reside on the World Wide Web, in a server for example that is accessed via the Internet from a remote location. Multimedia documents found on the World Wide Web are called Web pages. Linking information together with hyperlinks is accomplished by special computer programs or computer languages. Two computer languages used to create Web pages are called HyperText Markup Language (HTML) and JAVA. A multimedia device should have a keyboard and a pointing device, such as a mouse or pen, so that the user can direct the associations between multimedia elements.

A modem, which stands for modulator-demodulator, is a device that connects a computer to a telephone line and allows information to be transmitted to or received from another computer. Each computer that sends or receives information must be connected to a modem or other network interface, such as an interface card. The information sent from one computer is converted by a modem into an audio signal, which is then transmitted by telephone lines to the receiving modem, which converts the signal into information that the receiving computer can understand. Handshaking is the term used for the signal acknowledging that communication or the transfer of information can take place. Handshakes can be controlled by either hardware or software.

The Internet and most intranets are based on the concept of a client-server relationship between computers, also called a client/server architecture. To access information on the Internet or an intranet, a user must first log on, or connect, to the client computer's host network. This connection can be established with or without user intervention depending on the software.

Once a connection has been established, the user may request information from or send information to a remote server. If the information requested by the user resides on one of the computers on the host network, that information is quickly retrieved and sent to the user's terminal. If the information requested by the user is on a server that does not belong to the host Local Area Network (LAN), then the host network connects to other networks until it makes a connection with the network containing the requested server. In the process of connecting to other networks, the host may need to access a router, a device that determines the best connection path between networks and helps networks to make connections.

Once the client computer makes a connection with the server containing the requested information, the server sends the information to the client in the form of a file. A special computer program called a browser enables the user to view the file. Examples of Internet browsers are Mosaic, Netscape, and Internet Explorer. Non-multimedia documents do not need browsers to view their text-only contents and many multimedia documents provide access to text-only versions of their files. The process of retrieving files from a remote server to the user's terminal is called downloading. The process sending files to a remote server from a user's terminal is called uploading.

Photographs, drawings, and other still images can be changed into a format that computers can manipulate and display. Such formats include bit-mapped graphics and vector graphics. Bit-mapped graphics store, manipulate, and represent images as rows and columns of tiny dots. In a bit-mapped graphic, each dot has a precise location described by its row and column, much like each house in a city has a precise address. Some of the most common bit-mapped graphics formats are called Graphical Interchange Format (GIF), Tagged Image File Format (TIFF), and Windows Bitmap (BMP).

Vector graphics use mathematical formulas to recreate the original image. In a vector graphic, the dots are not defined by a row-and-column address, rather they are defined by their spatial relationships to one another. Because their dot components are not restricted to a particular row and column, vector graphics can reproduce images more easily and thus provide better output on most video screens and printers. Common vector graphics formats are Encapsulated Postscript (EPS), Windows Metafile Format (WMF), Hewlett-Packard Graphics Language (HPGL), and Macintosh graphics file format (PICT).

Video files can be quite large, so they are usually reduced in size using compression, a technique that identifies a recurring set of information, such as one hundred black dots in a row, and replaces it with a single piece of information to save space in the computer's storage systems. Common video compression formats are Audio Video Interleave (AVI), QuickTime, and Motion Picture Experts Group (MPEG or MPEG2). These formats can shrink video files by as much as 95 percent however, they may introduce varying degrees of distortion also. Animation can also be included in multimedia applications to add motion to images. Animations are particularly useful to simulate real-world situations, such as the flight of an airplane or a surgical procedure. Animation can also enhance existing graphics and video elements adding special effects such as morphing, the blending of one image seamlessly into another. Sound, like visual elements, must be recorded and formatted so the computer can understand and use it in presentations. Two common types of audio format are Waveform (WAV) and Musical Instrument Digital Interface (MIDI). WAV files store actual sounds, much as music CDs and tapes do. WAV files can be large and may require compression. MIDI files do not store the actual sounds, but rather instructions that enable devices called synthesizers to reproduce the sounds or music. MIDI files are much smaller than WAV files, but the quality of the sound reproduction is not nearly as good.

Multimedia elements included in a presentation require a framework that encourages the user to learn and interact with the information. Interactive elements include pop-up menus, small windows that appear on the computer screen with a list of commands or multimedia elements for the user to choose. Scroll bars, usually located on the side of the computer screen, enable the user to move to another portion of a large document or picture. Hyperlinks creatively connect the different elements of a multimedia presentation using colored or underlined text or a small picture, called an icon, on which the user points the cursor and clicks on a mouse.

Multimedia has had an enormous impact on education. For example, medical schools use multimedia-simulated operations that enable prospective surgeons to perform operations on a computer-generated “virtual” patient. Similarly, students in engineering schools use interactive multimedia presentations of circuit designs to learn the basics of electronics and to immediately implement, test, and manipulate the circuits they design on a computer. Multimedia is also used in commercial applications. Architects use multimedia presentations to give clients tours of houses that have yet to be built. Mail-order businesses can create multimedia catalogues that allow prospective buyers to browse virtual showrooms and even make purchases on-line.

### SUMMARY

Multimedia is used to help create presentations and also to efficiently evaluate those presentations. Disclosed is a database for storing, evaluating and displaying evaluation results of submitted proposals, wherein the database includes automated processes that assist reviewers in an evaluation process. The database includes a server that is connected to a network that stores and executes proposal software.

The proposal software includes an interface module that provides for inputting, searching and viewing proposal and evaluation information. The interface module also provides for the importation of files and multimedia data as part of a proposal, and allows a submitter multiple sessions with the same proposal before the proposal is designated as being ready for evaluation.

An evaluator software module includes virus scanning software and formatting software. The scanning software checks submitted information for viruses and eliminates detected viruses. The formatting software ensures submitted information can be displayed in a web site. The evaluation software also assigns submitted proposals to designated classes, and calculates weighted scores for designated portions within proposals.

The evaluation module further includes a notification module that provides notification to proposal submitters when more information about their proposal is required and, notifies reviewers when a submitted proposal is ready for action to be taken by the reviewer. Notification can be given by e-mail, instant messaging or by other electronic means. When an accumulated score has been generated by the evaluation module and the reviewers, a notification is sent to an approver.

A security module controls access to the database and to specific areas within the database.

Submitted proposals are stored as proposal files and each proposal file has an associated summary chart created by the database that displays evaluation information. The summary chart can be modified by the evaluation module and authorized reviewers. The summary chart includes scores generated for the proposal, reviewer comments, names of people, departments and companies involved, the status of the proposal, and a comparison summary between the proposal and other similar or related proposals.

The database may be accessed via the internet, and a web browser may be used to input and view proposal and evaluation information.

A common interface and submission process is provided for submitting all proposals to an organization or other entity.

The review and evaluation process is standardized, and portions of the evaluation process are automated to notify appropriate reviewers when the database completes an automated process.

### BRIEF DESCRIPTION OF THE DRAWINGS

FIG. 1 is a block diagram showing exemplary communication connections to the present evaluation database;

FIG. 2 is an exemplary flow chart showing steps that submitters and evaluators may follow in one embodiment;

FIG. 3 is a flow chart showing exemplary processes executed by the present database on submitted proposals;

FIG. 4 shows an exemplary user interface window;

FIG. 5 shows an exemplary proposal input window;

FIG. 6 shows another exemplary proposal input window;

FIG. 7 shows yet another exemplary proposal input window; and,

FIG. 8 shows an exemplary summary chart.

### DETAILED DESCRIPTION

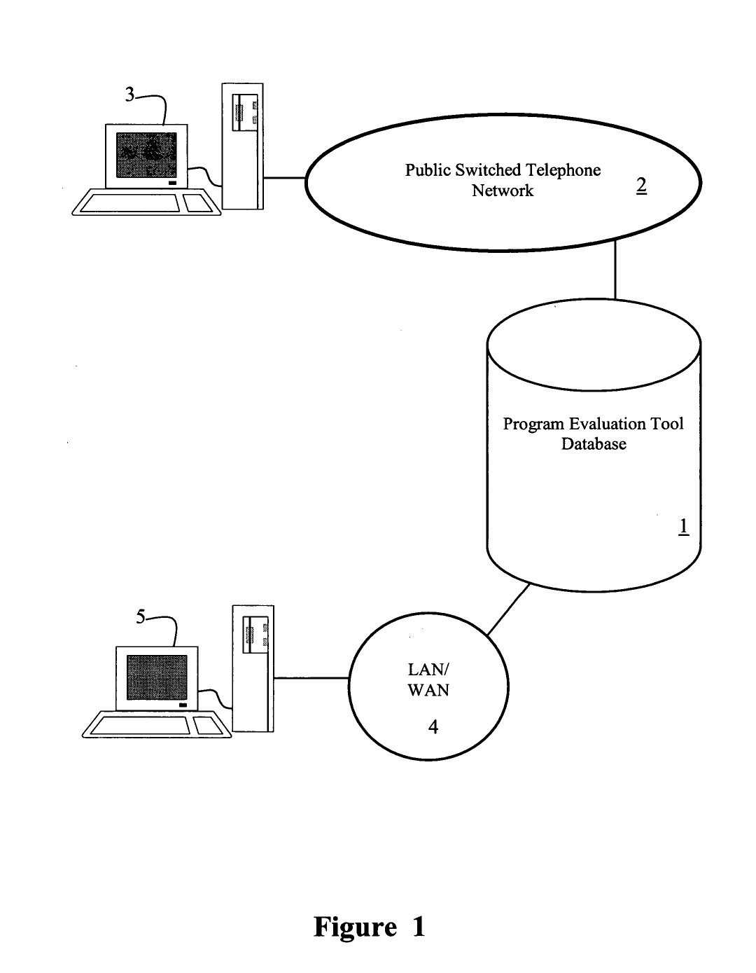

In this description, “evaluators” and “reviewers” are used interchangeably and typically refer to an actual person that has been assigned to the evaluate the proposal. Referring to FIG. 1, exemplary communication connections to the present database 1 are shown. Program Evaluation Tool (PET), another name for database 1, may be connected to a Public Switched Telephone Network 2 (PSTN) and communication occurs via the Internet. However, database 1 can also be connected to a private Local Area Network 4 (LAN) or Wide Area Network (WAN) and provide for communication over the private network. A user at computer 3 may use an Internet browser to interface with database 1. The user at computer 5 may also use a browser program as the interface, or they may use another interface program. Most users of database 1 are either proposal submitters or proposal evaluators. Database 1 provides a common interface for the submission of all types of proposals to an organization. In large organizations, there are a wide variety of proposals submitted to the organization for consideration. Most proposals are specific to a limited area within the organization, however, some may be broad and relate to policy. Database 1 provides a common interface and evaluation process for all proposals. Some of the evaluation processes, such as classification and weighted scoring, are done automatically by database 1 and other evaluation processes are done be the evaluators.

Database 1 has multiple memory and associated software modules, discussed further below. Database 1 physically resides on one or more servers. In an exemplary embodiment, a web server is configured to run Cold Fusion programs. Memory modules with database 1 may contain thousands of files and each file may contain millions of bits. At least one memory module is dedicated to the storage of proposal files. Proposal files are created by one or more submitters and may contain information regarding a variety of concepts, projects and other proposals for the organization. Proposal files may include multimedia files that are preferably stored and displayed in the same format in which the file was originally saved. To facilitate this ability data base 1 stores information in data sets. Format files within database 1 support the storage and retrieval of data in multiple formats.

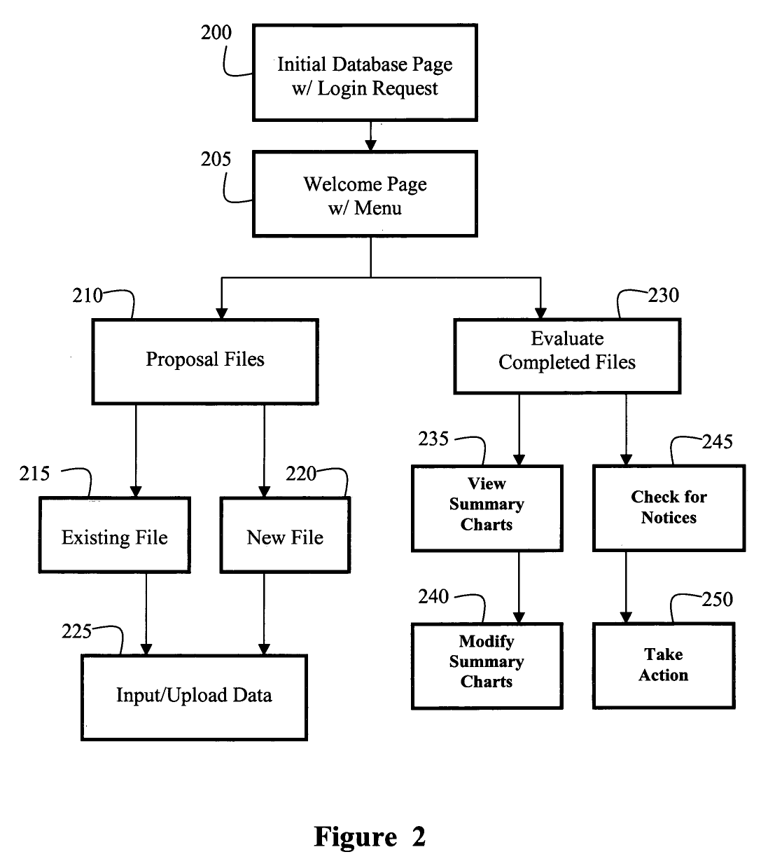

FIG. 2 shows a general flow chart of options available to users of the present database. In the methods of FIG. 2 the users are using an Internet browser program as the interface to the present database. At step 200 the user is presented with a window containing text and graphics that identify the site/database and requests logon information from the user. The logon information requires the entry of user specific information and may comprise one or more fields of data. The provided data is screened through a security program of the user interface software and an appropriate level of access is granted to the user. At step 205, a menu of options available to the user is displayed for their selection. Of course, restrictions are in place and generally submitters will not be able to access evaluator files. If the user is an authorized proposal submitter, then the user may select Proposal Files (step 210) where the submitter is allowed access to an existing file (step 215) or the user may create a new proposal file (step 220). The submitter is then guided through the submission process (step 225). Exemplary input windows that prompt the submitter for specific information are discussed below.

If the user is an evaluator then (step 205) the evaluator may select Evaluate Completed Files (step 230). Here the evaluator has access to designated proposal files. The evaluator may review summary charts of proposal files (step 235) to continue the evaluation process. The database automatically generates a summary chart for each proposal that provides up-to-date summary information relating to the proposal. Information displayed in the summary charts can be modified automatically by the database and by evaluators (step 240). From the evaluator interface, the evaluator may also check to see if there are any notices, indicating that there is any evaluation action that he needs to take (step 245). Notices may also be sent to evaluators via email and other well-known computer generated electronic communication methods. At step 250, the evaluator may access required files, including the one or more proposal files mentioned in the notice, and take whatever action is necessary to carry on and possibly complete the evaluation process.

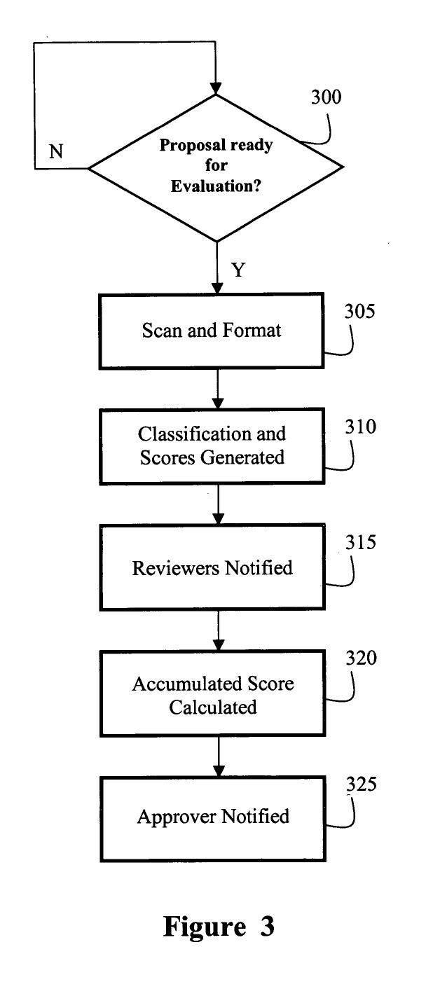

FIG. 3 illustrates exemplary evaluation steps that are automatically taken by the present database. The evaluation process usually does not begin until the submitter has designated the proposal file and indicates being ready for evaluation. At step 300, the database scans the proposal files looking for a flag that is set by the submitter designating the file as ready for evaluation. Once such a proposal file is found (step 305) the files is scanned for viruses and detected viruses are eliminated, using methods that are well-known in the art. At step 305 the proposal file also receives any required formatting that will ensure all information can be viewed via a web browser. At step 310, key words in the file are used to classify the proposal into one or more classes that are designated in advance by an administrator. The database administrator also presets weights that are assigned to different classes of proposals, and to different portions within a proposal, and (step 310) the database generates weighted scores for the file being evaluated.

Step 315 illustrates the automatic notification feature of the present database. Whenever an actual person is required to take some action in the evaluation process, notification is sent to the required persons. Reviewer, evaluator, or administrator intervention may be required more than once during evaluation of a file and the database supports all required notifications. Once all required evaluation inputs have been entered by the reviewers and the database, an accumulated score is calculated for the proposal (step 320). This completes a majority of the evaluation process and (step 325) an approver is notified that an evaluated proposal is ready for consideration.

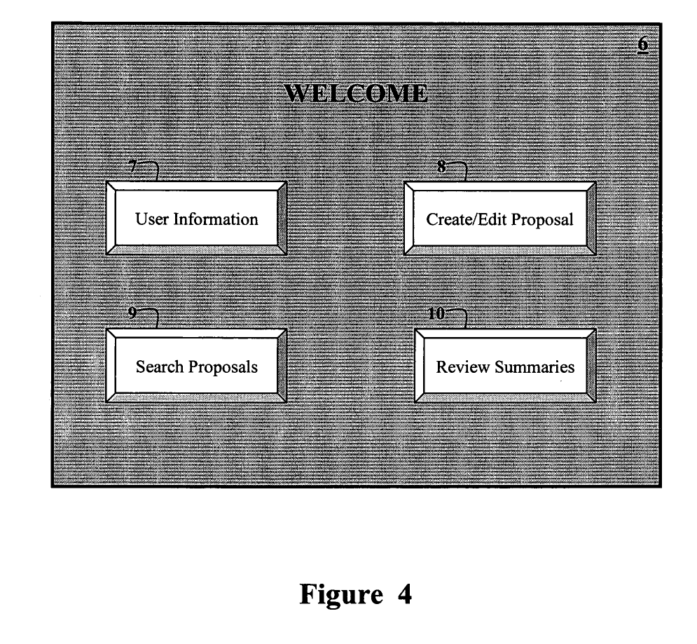

FIG. 4 shows an exemplary “welcome” window 6 for the database, which users are taken to after logging on to the database. By clicking on user information button 7, a user can keep his/her user identification and contact information current. If the user is a proposal submitter, then he/she will click on button 8 to create or continue editing a proposal. Search proposals button 9 allows authorized users to search and view proposals based on the results of a key word search. Review summaries button 10 will take an evaluator to evaluation windows where he/she can view and edit summary charts.

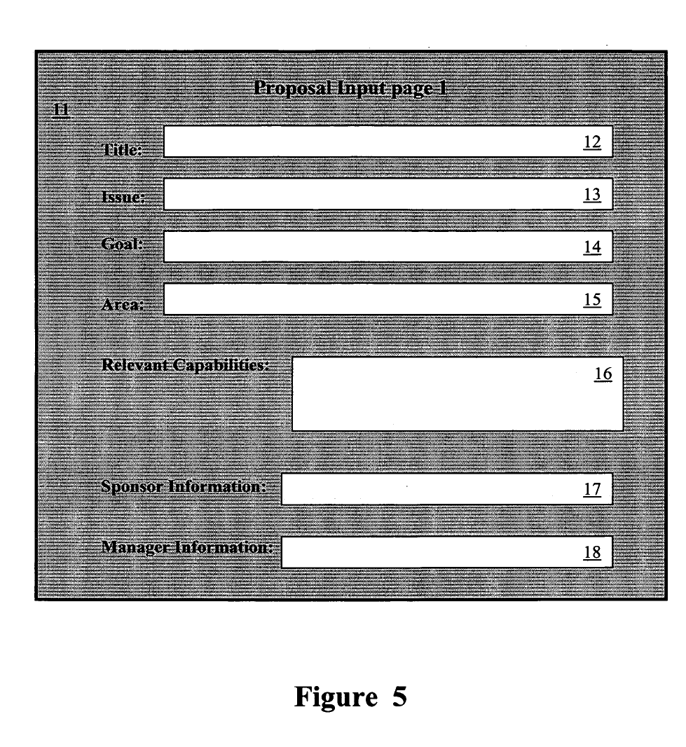

FIG. 5 shows an exemplary proposal input page that prompts the submitter for proposal information. Exemplary requested data include: title of the proposal 12; issue to which the proposal relates 13; goal of the proposal 14; the designated area in which the proposal impacts; and other information relating to the proposal 16-18 that helps convey the idea of the proposal.

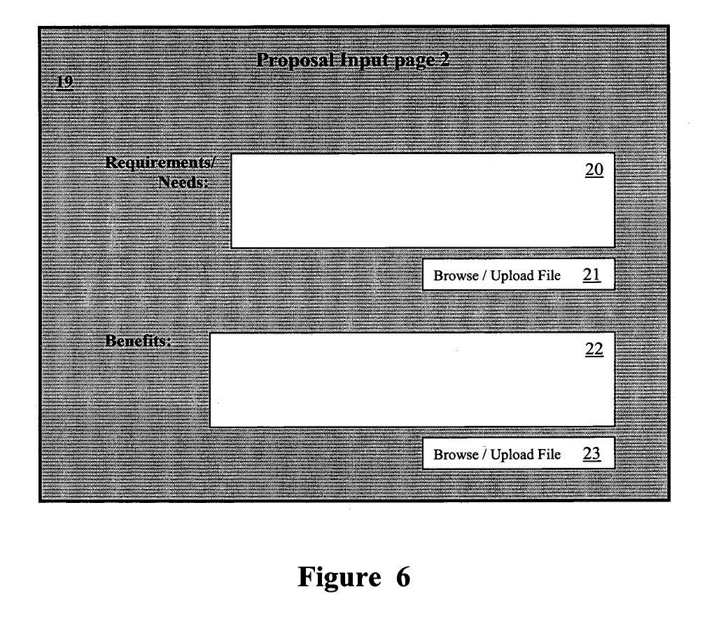

FIG. 6 shows another exemplary proposal input page 19. The submitter may enter text manually in windows 20 and 22. The submitter may also upload existing files directly into the database by using buttons 21 and 23.

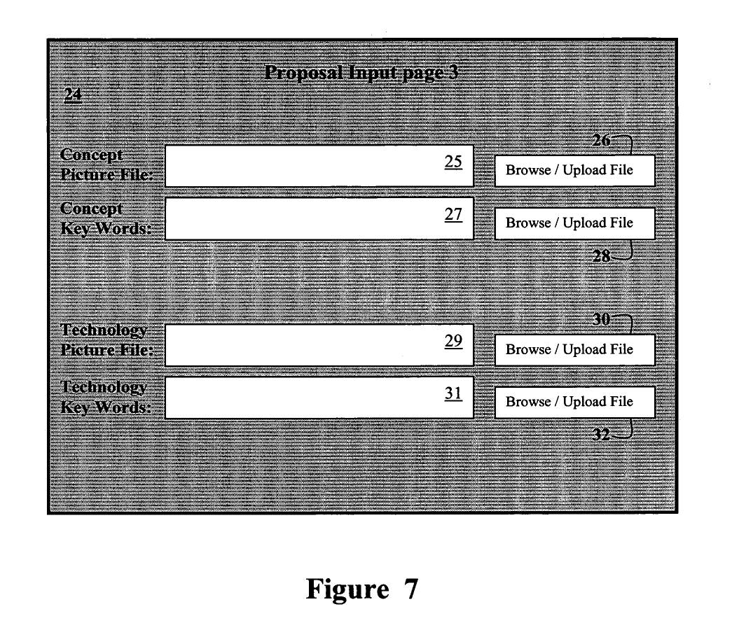

FIG. 7 shows a third exemplary proposal input page 24. As with the other input pages, the submitter is prompted for specific information. Again, the submitter may manually input text into windows 25, 27, 29 and 31, or the submitter can upload existing files using buttons 26, 28, 30 and 32. Such uploading capabilities greatly streamlines the submission process. The present database lets submitters take advantage of previous work that has been saved in an electronic format.

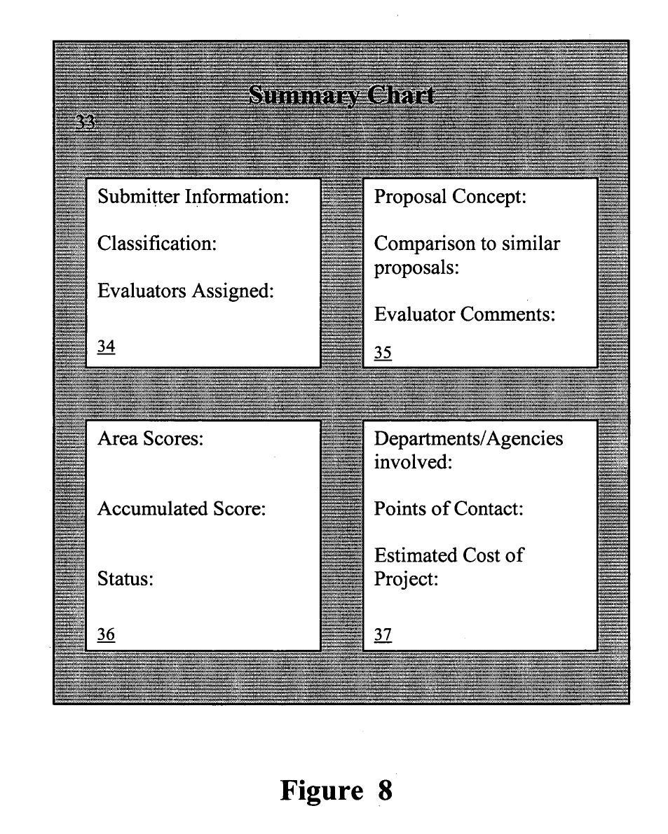

FIG. 8 shows an exemplary Summary Chart 33 that is displayed to evaluators during the evaluation of a proposal file. Window 34 shows the name(s) of the creator(s), an assigned classification, and the evaluators assigned to evaluate the proposal. Window 35 shows a brief summary of the concept contained in the proposal, a comparison to other similar proposals, and evaluator comments. Summary chart window 36 shows scores relating to the proposal including at least one accumulated score, and the current status of the proposal.

Window 37 list information relating to all other departments and agencies that are to some extent involved in the proposal, the points of contact including names, telephone numbers and email addresses, and an estimated cost of executing the proposed project. Any of the above summary windows may have some data automatically calculated by database programs and the date may be edited by authorized evaluators. Other embodiments provide for displaying other information in the summary charts, and the information shown in the FIG. 8 is meant to be exemplary and not limiting.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be included within the meaning and range of equivalents of the disclosed embodiments. It is to be understood that the phraseology of terminology employed herein is for the purpose of description and not of limitation.

I claim:

1. A database for storing, evaluating and displaying evaluation results of submitted proposals, wherein the database includes automated processes that assist reviewers in the evaluation process, the database comprising:
a server connected to a network that stores and executes proposal software, wherein the proposal software comprises:
an interface module that provides for inputting, searching and viewing proposal and evaluation information;
an evaluation module comprising:
a classification module that assigns submitted proposals to designated classes; and,
a scoring module that assigns weights to designated portions within proposals and generates scores for the proposals; and,
a security module that limits access to the database and to specific areas within the database.

2. The database of claim 1, wherein submitted proposals are stored as proposal files and at least one proposal file has an associated summary chart created by the database that displays evaluation information, wherein the summary chart can be modified by the evaluation module and authorized reviewers.

3. The database of claim 1, wherein the evaluation module further includes a notification module that provides notification:
to proposal submitters when more information about their proposal is required; and,
to reviewers when a submitted proposal is ready for action to be taken by the reviewer.

4. The database of claim 1, wherein the interface module provides for importation of files and multimedia data as part of a proposal, and wherein the interface module allows a submitter multiple sessions with a same proposal before the same proposal is designated as ready for evaluation.

5. The database of claim 1, wherein the network is the Internet and information can be input and viewed via a web browser.

6. The database of claim 3, wherein notification is given by e-mail or by instant messaging, and wherein when an accumulated score has been generated by the evaluation module and the reviewers, a notification is sent to an approver.

7. A multimedia database connected to a network that provides a common interface for the input of a variety of proposals for an organization, wherein the database includes automated processing of submitted proposals, comprising:
a sever that stores and executes database software, wherein the data base software provides:
an user interface that accepts proposal information from the user, wherein the proposal information may include multimedia data; and,
evaluator software that assists in processing submitted proposals by assigning evaluation scores to the proposals and alerting appropriate evaluators when it is time for the evaluators to take action.

8. The database of claim 7, wherein the evaluator software includes:
virus scanning software that checks submitted information for viruses and eliminates detected viruses; and,
formatting software that ensures submitted information can be displayed in a web site.

9. The database of claim 7, wherein the evaluation software accepts input of reviewer comments that can be displayed in a summary chart associated with each proposal wherein the summary chart also includes the scores given to the proposal, names of people, departments and companies involved, a status information, and a comparison summary with other proposals.

10. The database of claim 7, wherein the evaluation software uses the assigned evaluation scores and inputs from the evaluators to generate an accumulated score for proposals and then sends notification of an evaluated proposal to an approver.

11. A method for storing, evaluating and displaying evaluation results of proposals that are inputted into a database, wherein a server that is connected to a network stores and executes proposal software that provides user interfaces for submitters of proposals and for reviewers of the proposals, and wherein the database assists in an evaluation process of submitted proposals, the method comprising:
using an interface software module to input, search and view proposal and evaluation information;
providing an evaluation software module comprising:
a classification module that assigns submitted proposals to designated review areas; and,
a scoring module that assigns weights to designated portions of submitted proposals and generates scores for the designated portions; and,
limiting access to the database and within the database to users with proper security level authorizations.

12. The method of claim 11, wherein the submitted proposals are stored as proposal files and each proposal file has an associated summary chart that is created by the database, wherein the summary chart can be modified by the evaluation module and by the reviewers.

13. The method of claim 11, further comprising:
using a notification module that provides notification:
to proposal submitters when more information about their proposal is required; and,
to reviewers when a submitted proposal is ready for action to be taken by the reviewer.

14. The method of claim 11, wherein the interface module provides for importation of files and multimedia data as part of a proposal, and wherein the interface module allows a submitter multiple sessions with a same proposal before the same proposal is designated as ready for evaluation.

15. The method of claim 11, wherein the network is the Internet and information can be input and viewed via a web browser.

16. The method of claim 13, wherein notification is given by e-mail or by instant messaging.

17. The method of claim 11, wherein providing evaluation software further includes providing:
virus scanning software that checks submitted information for viruses and eliminates detected viruses; and,
formatting software that ensures submitted information can be displayed in a web site.

18. The method of claim 12, wherein the summary chart is used to display scores that have been generated for proposals, wherein each proposal has at least one accumulated score, and the summary chart also displays names of people, departments and companies involved, a status information, and a comparison summary with other related proposals.

19. The method of claim 11, wherein the evaluation software uses the generated scores and inputs from the reviewers to generate an accumulated score for proposals and then sends notification of an evaluated proposal to an approver.
